(19) United States
(12) Patent Application Publication
(10) Pub. No.: US 2012/0085189 A1
(43) Pub. Date: Apr. 12, 2012

(54) INFINITELY VARIABLE TRANSMISSION MECHANISM

(76) Inventor: Thomas E. COE, Northwood, NH (US)

(21) Appl. No.: 13/267,847

(22) Filed: Oct. 6, 2011

Related U.S. Application Data
(60) Provisional application No. 61/390,393, filed on Oct. 6, 2010.

(51) Int. Cl. F16H 1/06; B23P 15/14

(52) U.S. Cl. 74/415; 29/893.2

(57) ABSTRACT

An infinitely variable transmission mechanism that transmits produced torque to a wheel or output shaft without gears and is capable of an expansive range of active gear ratios in a relatively small envelope

This application claims the benefit of U.S. provisional application No. 61/390,393 filed Oct. 6, 2010 and entitled Infinitely Variable Transmission Mechanism (Attorney Docket No. COETHO P04AUSPR), which is hereby incorporated herein by reference in its entirety.

### FIELD OF THE INVENTION

The present invention relates to an infinitely variable transmission mechanism that transmits produced torque to a wheel or output shaft without gears and is capable of an expansive range of active gear ratios in a relatively small envelope.

### BACKGROUND OF THE INVENTION

Mechanical gearing is used in almost any device having rotating parts, for example, bicycle gearing allows for a selection of an appropriate gear ratio for the speed and efficiency in varied physical terrains. An adjustment to the gear ratio adjusts the amount the bicycle moves forward on each pedal stroke. Based on the number of teeth on each sprocket gear of the bicycle, the smaller wheel gear rotates faster than the larger pedal gear with the ratio of the number of teeth determining the revolutions per minute (rpm) of each gear and thereby the overall speed of the bicycle.

Adjustments to gear ratio on a bicycle or a car transmission require multiple gears of varying diameters stacked and aligned within a gearing system. Motors, belts, and other adjustment mechanisms are used to move and change the alignment of the gears within the gearing system to adjust the rotational speeds. For slower speeds, sets of larger gears are required and for faster speeds sets of smaller gears are required with limiting factors being the cost, space and rate required to achieve appropriate gear ratio ranges for functional operation of the vehicle or other equipment.

What is needed is a transmission system that uses fewer numbers of gear sets and adjustment mechanisms while achieving acceptable gear ranges to operate machinery safely and efficiently.

### OBJECTS AND SUMMARY OF THE INVENTION

The present invention relates to an infinitely variable transmission mechanism which is mechanically engaged to a power system.

An object of the present invention is to reduce the gears required within a variable transmission system while maintaining an appropriate range of active gear ratios.

Another object of the invention is to reduce the space and weight requirements of a variable transmission drive system.

Another object of the present invention is to provide automatic shifting of drive components within the transmission system to accommodate variable loading cycles.

Another object of the invention is to communicate power between misaligned shafts with multiple degrees of freedom in a variable power transmission system.

A further object of the invention is to stack the transmission system and gears in a compact series arrangement to achieve multiple and infinitely variable ranges of active gear ratios.

The present invention is related to a variable power transmission mechanism for producing a desired torque comprising at least one hub having a slot aligned along a shaft; at least one drive ring having at least one pin assembly positioned adjacent the at least one hub along the shaft; at least one array plate positioned adjacent the at least one drive ring; and wherein adjustment of the hub and slot relative to the shaft forces the at least one pin assembly to engage the at least one array plate and change the torque produced by the variable power transmission mechanism.

The present invention is further related to a method for producing a desired torque from a variable power transmission mechanism comprising the steps of aligning at least one array plate along a stationary axle; aligning at least one drive ring having at least one pin assembly adjacent the array plate; affixing at least one adjustable hub to the axle adjacent the drive ring; and moving the adjustable hub to force the at least one pin assembly to engage the array plate and alter the torque produced by the variable power transmission mechanism.

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is an exploded view of a first embodiment of the present invention;

FIG. 1A in an exploded view of a first embodiment of a pin assembly of the first embodiment of the present invention;

FIG. 2 is a perspective view of a first embodiment of the present invention with the position hub aligned along the center line of the stationary axis;

FIG. 3 is a perspective view of the first embodiment of the present invention with the position hub at a maximum torque position relative to the center line of the stationary axis;

FIG. 3A is a detailed view of the pin assembly supported on a ledge of the position hub of a first embodiment of the present invention;

FIG. 4 is a perspective view of pins engaging the arrays and being overrun by the arrays of the array plate of a first embodiment of the present invention;

FIGS. 5A and 5B are elevation views of the first embodiment of the present invention showing maximum and minimum torque positions;

FIG. 6 is an elevation view of an engagement of a pin assembly with the array plate of a further embodiment of the present invention;

FIG. 7 is an elevation view of an engagement of a second pin assembly with the array plate of a further embodiment of the present invention;

FIG. 8 is an elevation view of an engagement of a third pin assembly with the array plate of a further embodiment of the present invention;

FIG. 9 is an elevation view of an engagement of a fourth pin assembly with the array plate of a further embodiment of the present invention;

FIG. 10 is a still further embodiment of the present invention in a fixed shaft application using a cross drive system;

FIG. 11 is a still further embodiment of the present invention in a fishing reel application; and

FIG. 12 is a still further embodiment of the present invention in a series configuration.

### DETAILED DESCRIPTION OF THE PREFERRED EMBODIMENTS

In its simplest form the infinitely variable transmission mechanism is made up of four major components; an array or channel plate 10, a drive ring 12, one or more pin-assemblies 14 and a movable position hub 16. All the components are in a compact sandwich arrangement. By simply moving the position hub 16 above or below the center line C of the array plate 10 the active gear ratio is changed with the output ratio being directly proportional to the distance moved. While positioned at dead center a 1:1 ratio is realized. When the position hub 16 is moved in a first direction, a speed reduction is induced, and when moved in an opposing direction, a speed increase occurs. This compact and simple arrangement can be applied to many types of equipment for example fishing reels, winches, bicycles, wheel chairs, generators, transport vehicles, and other machinery having rotating mechanisms.

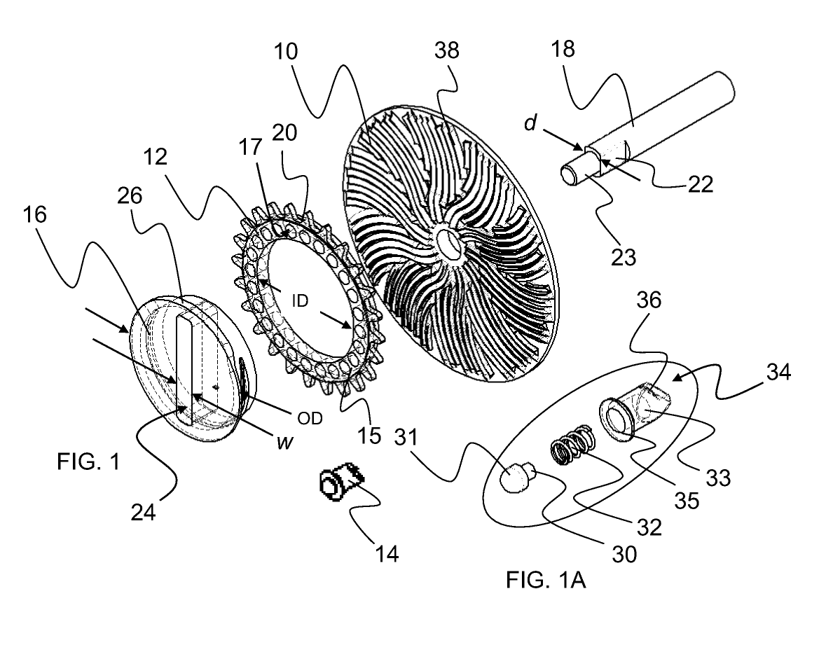

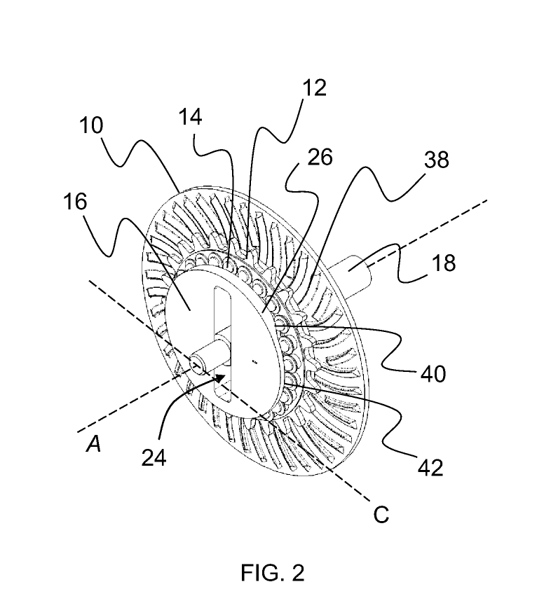

As illustrated in FIG. 1, the four major components are mounted about a stationary axle 18 with the drive ring 12 shown with a bicycle type chain sprocket 20 on its perimeter. The array plate 10 and the drive ring 12 are placed in close proximity perpendicular to the axis A of the stationary axle 18. The array plate 10 has a number of pitch arrays, channels grooves or slots 38 that extend out from the center of the plate 10. These arrays may extend radially or be substantially curved as shown in FIG. 1. A number of pin assemblies 14, as an example approximately twenty-four (24) are nested in openings 17 around an outer rim 15 of the drive ring 12. The position hub 16 in an initial position affixed along the center line C has an outer diameter OD slightly smaller than the inner diameter ID of the drive ring 12 so that the hub 16 fits through the center of the drive ring 12 as seen in FIG. 2. The center shaft 23 of the axle 18 may extend through a position hub slot 24. Flats 22 of the axle 18 are of a slightly smaller width d than the width w of the slot 24 so that the flats 22 fully enter and engage the edges of the slot 24.

The pin assembly 14 as shown in the exploded view of FIG. 1A has substantially four components, a plunger pin 30, a nested spring 32, a tooth body 33 and a support rim 35. The plunger pin 30 has a rounded top 31 that slides along the surface 42 of the position hub 16. The spring 32 and plunger 30 bias the tooth body 33 towards and into the array, groove, slot or channel 38 of the array plate 10 to provide system torque. The tooth body 33 has a jutted face profile 34 with a ramp feature 36, this feature allows for the pin assembly 14 to compress and adjust when overrun by an array of the array plate 10. The support rim 35 holds the plunger pin 30 away from the array plate 10 during a segment of the rotation as will be described in greater detail below. The support rim 35 may have a scalloped radius matching the profile of the position hub perimeter to assist in preventing rotation. In a further embodiment, the pin assembly may be jeweled incorporating a rounded or roller element in place of the tooth face profile.

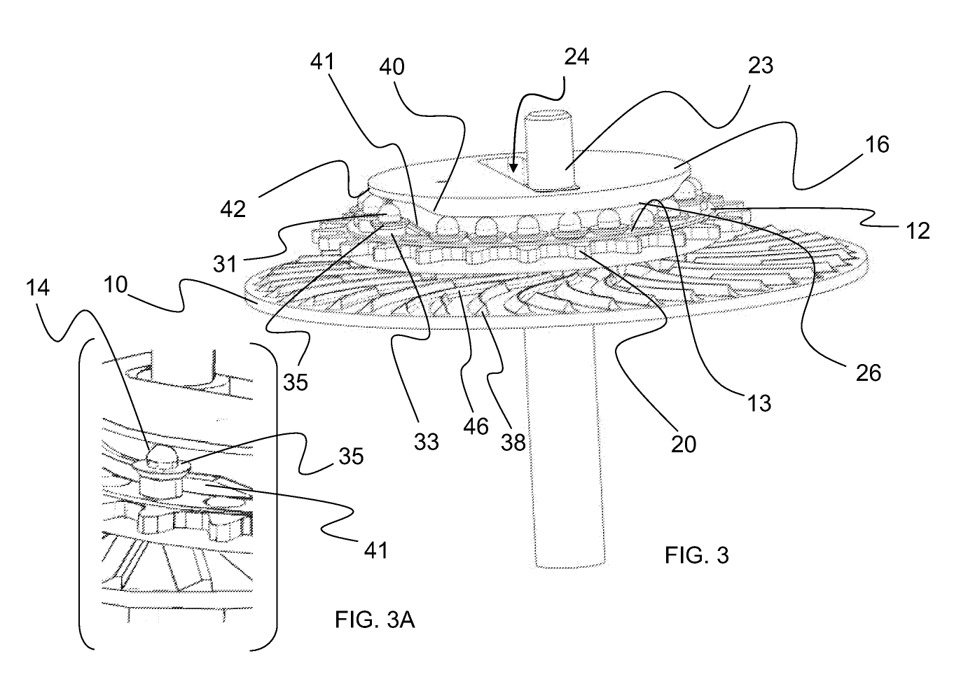

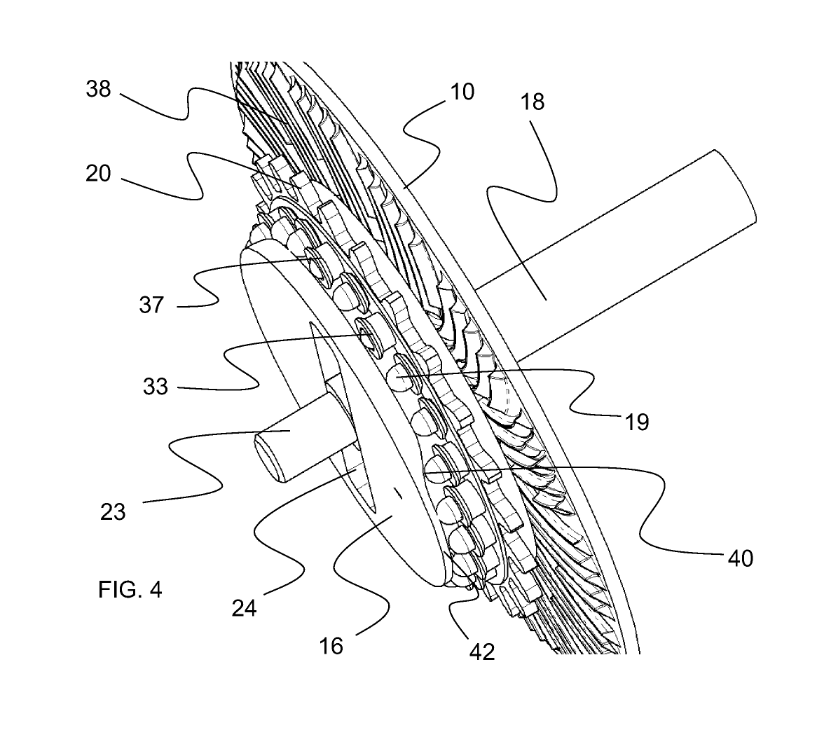

When an ample tangential force is applied to the sprocket 20 of the drive ring 12 the drive ring will rotate around the stationary axle 18 within the position hub 16 while carrying a quantity of pin assemblies 14. As shown in FIG. 3, the drive ring 12 with the pin assemblies 14 is aligned adjacent the array plate 10 with the position hub 16 aligned adjacent the drive ring 12. The under surface of the position hub 42 has a shoulder 40 that transitions to a cam lobe 26. As the drive ring 12 rotates around the stationary axle 18 the rounded top 31 of the pin assembly 14 rides along the under surface 42 of the position hub 16, transitions through the shoulder 40 and is moved towards the cam lobe 26. The cam lobe 26 extends around a segment of the position hub 16 to a range of between 80 degrees and 130 degrees, and more preferably to a range of 100 degrees and during this segment, this movement biases the jutted face profile 34 of the pin assembly 14 through the drive ring 12 to engage the array plate 10. One or more pins 14 are brought into contact with the array 38 or are held up by the tops of the arrays 38 to the cam lobe 26 as the drive ring 12 and array plate rotate 10. As the pin assemblies 14 enter or engage the pitch arrays 38 torque is communicated causing the speed of rotation to slow. During this cam lobe 26 segment not every pin will engage an array 38 but may instead be held up by or be overrun by the array 38 with the nested spring 32 of the pin compressing and lifting the pins 33 and 37 as shown in FIG. 4.

Turning back to FIG. 3A, at the end of the cam lobe 100 degree segment of rotation the support rim 35 of the pin assembly 14 rides up and onto the hub support shelf or ledge 41 that extends approximately 260 degrees around the position hub 16 in parallel to the under surface 42 and shoulder 40 to the point where the cam lobe 26 begins. At this point the pin assembly 14 transitions from the support shelf 41 to the surface 13 of the drive ring where one or more pins are compressed by the cam lobe 26 and forced through the drive ring 12 to engage the arrays 38 of the array plate 10.

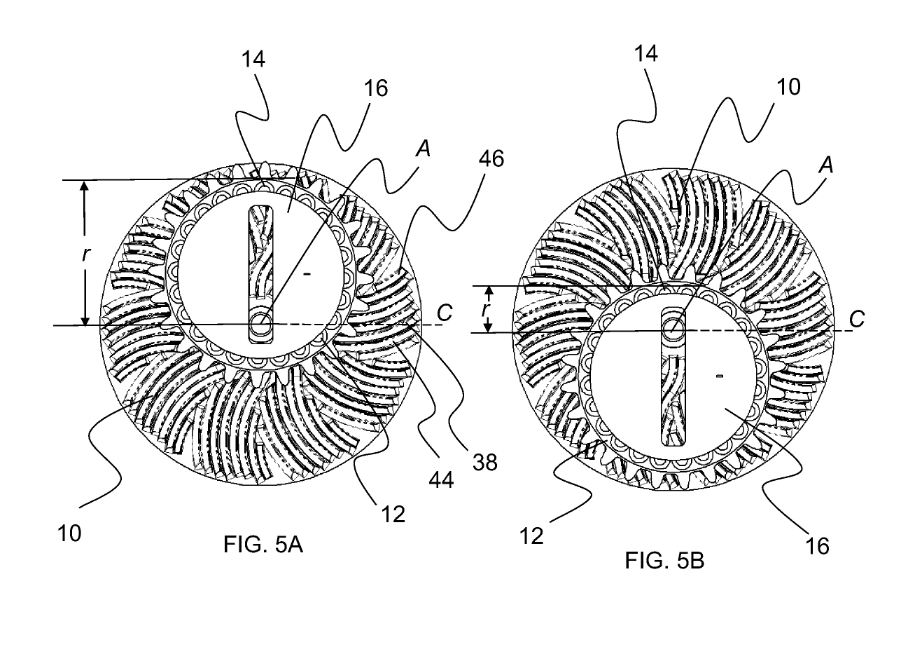

The amount of force and resultant torque applied to the drive ring 12 is dependent upon the position of the position hub slot 24 in relation to the stationary axle 18. As the position hub 16 moves in one direction using an external force along the slot 24 to a first position or in the opposite direction to an opposing position the radial distance 2r of the pin assembly of the drive ring will be increased or decreased as measured from the center line C of the output shaft 18 modifying the active ratio. This change in radial distance is shown in FIGS. 5A and 5B. The ratio induced is a function of the distance of the array plate center axis A to the contact point of the actively loaded pin multiplied by two and divided by the pitch diameter of the drive ring pin opening 17. FIG. 5A shows the variable transmission mechanism in low gear for maximum torque and FIG. 5B show the system in high gear for maximum speed.

The position hub 16 has three significant functions and features, the first function is to hold the drive ring 12 in the desired position within the slot 24 with regards to the center axis A of the stationary shaft 18 using an external adjustment force mechanism (not shown) to position the hub 16; second it provides a journal for the drive ring 12 to rotate upon; and third it controls the pin engagement by either forcing the pin assemblies 14 out towards the arrays 38 of the array plate 10 via the axial cam lobe 26, or preventing engagement by holding the support rim 35 of the pin along the hub support shelf 41 pulling the pin assembly 14 away from the array plate 10 as shown in FIG. 3A. The drive ring 12 has two major functions, first to carry the pin assemblies 14 around the position hub 16 and second to transmit the incoming torque to the pin assemblies 14 once they have engaged the arrays 38 of the array plate 10.

The pin assembly 14 has one main function, the transmission of torque; this requires having several features of importance, first the tooth face profile 34 which engages an array of the array plate 10. Extending from the tooth profile 34, the tooth body 33 has a ramp feature 36 that provides for the tooth assembly 14 to compress its internal spring 32 and move away from the array plate as the tooth body 33 is over run by the arrays 38 of the array plate 10. The pin spring 32 readily compresses if a tooth body 33 is misaligned with an array 38 and therefore the compressed pin 14 does not inhibit the rotation of the drive ring 12 or the array plate 10. There is also enough clearance within the cam lobe segment 26 so that the pin may be pushed towards the cam lobe 26 when the spring 38 is fully compressed, as seen in FIG. 4. In this figure as described above pin 33 and 37 have misaligned with an array 38 of the array plate and compressed against the cam lobe 26 as the tooth body 33 does not enter the array 38 or provide torque to the system. When properly aligned as shown by pin assembly 19, the nested spring 32 and plunger 30 bias the pin body 33 to enter the arrays 38 of the array plate 10.

The array plate 10 has two main functions, first is to allow and maintain contact with the pin assemblies 14 allowing them to raise and lower unimpeded by the arrays; second is to transmit the produced torque and speed to the wheel or output shaft (not shown). With respect to the array plate geometry a relationship with the drive ring 12 has significant engagement importance. Attempts at making Huntington Ratios or odd-to-even engagement relationships have resulted in poor performance or failure of the pin assemblies to engage or unload prior to reaching the extraction point. However, as shown in the current embodiment direct proportional relationships have been successful, where there are twice as many pin assemblies 14 as arrays 38 on the array plate 10.

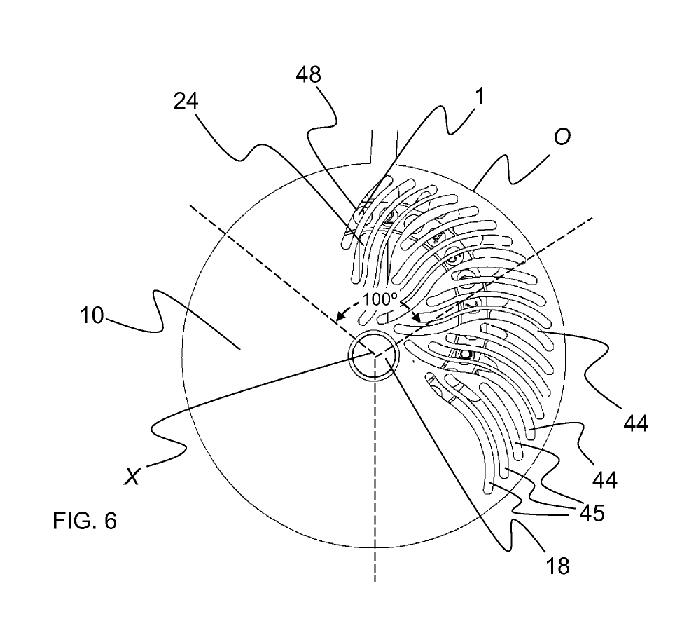

In determining the geometry of the array plate 10 the number of pin assemblies 14 of the drive ring are divided by two and this number of primary arrays or slots 44 are extended radially from the center X of the array plate 10 as shown in FIG. 6 towards the outer edge O of the plate 10. Extending the arrays 44 radially in straight lines causes the distance between each primary array 44 to expand. Parallel constant pitch arrays 45 of varying lengths are then added between the primary arrays 44. The constant pitch of the parallel arrays is substantially equivalent to the circular pitch of the pin openings 17 of the drive ring providing better frequency of engagement and loading and unloading of the pins 14. These parallel constant pitch arrays 45 are repeated as many times as practical based on the surface area of the array plate 10. Each array 44, 45 has a steep side and a gradual side that allows the pin assemblies 14 to be overrun by the array 44, 45, but not to jump an array once a pin has entered. The parallel or circular pitch edges may have jagged edges or ridges 46 that are decreasing in length as they run along one or both of each wall of the array to assist in engaging the pin 14 within the arrays 44, 45. This curved geometry of the arrays 44, 45 assists in the loading and unloading of the pin assemblies 14 through each cycle of rotation, however more exaggerated profiles may have the effect of decreased performance. It is clear that with the right geometry and curve an automatic response to an external load can be induced. For example, if a high load is placed on the spool of a fishing reel, the loading could force the pin assemblies 14 to travel within and up the arrays 44, 45 of the array plate 10; and in effect automatically shift into a lower gear ratio. When the gear ratio is at a setting of 1:1, the apex X of the 100 degree window as shown in FIG. 6 is at the center of the stationary axle 18, with the center line of the 100 degree window aligned along the center of the position slot 24.

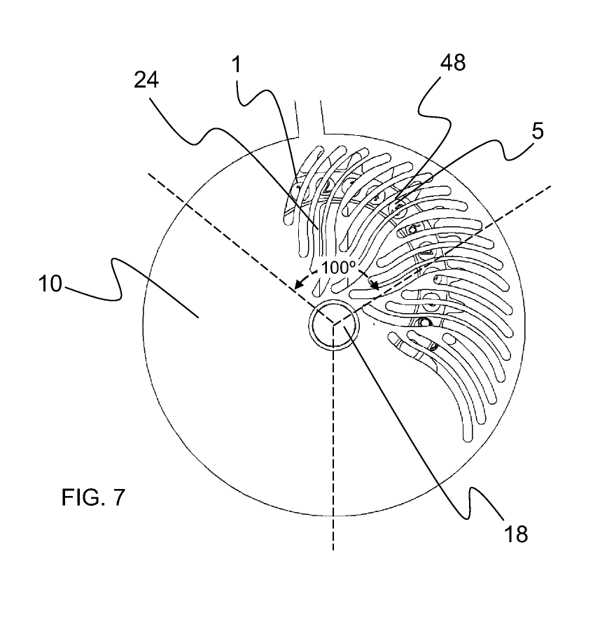

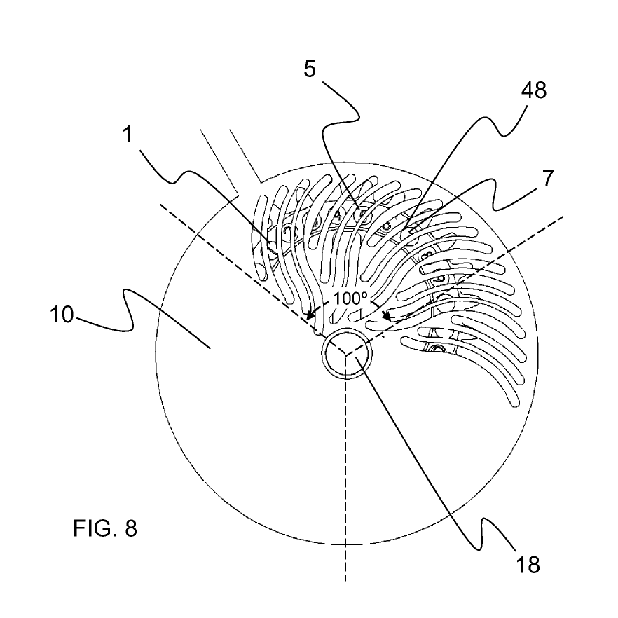

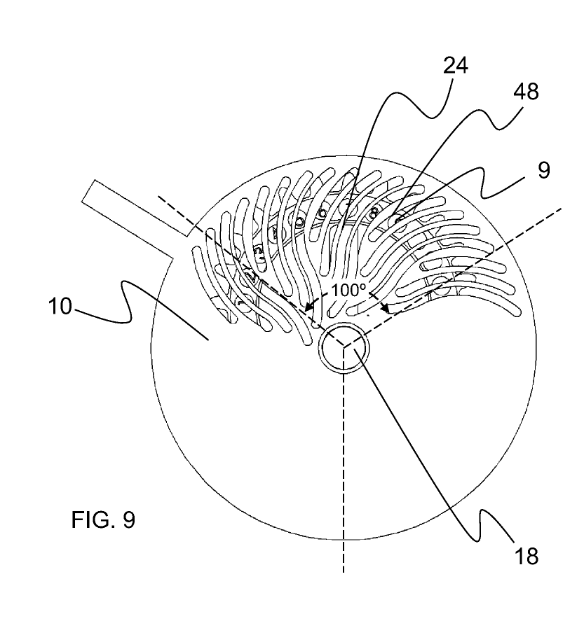

FIGS. 6-9 show several illustrations of a typical pin engagements and the unique properties that an embodiment of this design possesses. In the first illustration of FIG. 6 the system is in a reduction mode, pin 1 is in contact with the slot edge 48 in the 100 degree engagement window. In FIG. 7, as the drive ring sprocket 20 rotates counter clockwise pin 5 is accelerated and enters the 100° window and contacts the array edge 48 of the array plate 10. In FIG. 8, pin 7 is now in contact with pin 9 accelerating up into the contact window. The contact occurs within 30 to 45 degrees. Most notably pin 1 has now been unloaded as it decelerates and will stay unloaded all the way to the point where it will be retracted from the arrays 44, 45 of the array plate 10 at the end of the 100 degree window. And finally in FIG. 9 we see pin 9 in contact with the array edge 48 of the array plate 10 and picking up the load from pin 7. This process of loading, unloading and overrunning is accommodated by the ramp feature 36 on the back side of the pin body 33 in cooperation with the plunger 30 and plunger spring 32 arrangements as previously described.

With each revolution of the drive ring 12, the position hub 16 adjusted to a first position at a distance above the center line C and will force an engagement of one or more of the pins 14 to the arrays 44, 45 increasing torque and lowering the speed of rotation of the drive ring 12 and array plate 10. The cam lobe 26 forces the pin assemblies 14 to protrude out of the drive ring 12 and engage the array plate 10. During this time, one, two, or more pin assemblies 14 will engage the arrays 44, 45 of the array plate 10. At the end of the cam lobe segment the pin assemblies 14 are pulled away from the plate 10 by the support rim 35 riding up and onto the support shelf 41 as described above. The support rim 35 of the pin assembly 14 holds the pin away from the array plate until the pin assembly 14 returns to within the 100 degree segment of the cam lobe 26.

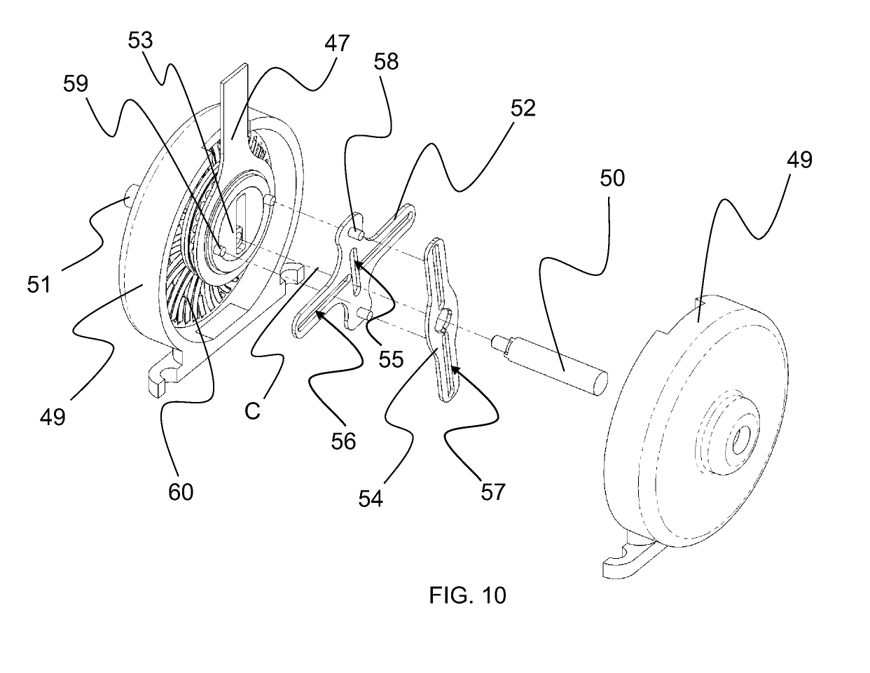

The illustration in FIG. 10 shows a fixed shaft application using a cross drive power delivery system. In this embodiment the transmission system within a housing 49 is similar to that previously described however the input 50 and output shaft 51 are concentric, so the input power using an external force or adjustment mechanism 47 must now be communicated to the center hub 53 that can travel to a first position and an opposing position from the center axis C of the input and output shafts 50, 51.

The cross-drive system is made up of two major components, the drive slot plate 52 and cross side plate 54. The drive slot plate 52 transmits the power from the input shaft 50 and communicates the energy through the slot 55 to the cross slide plate 54 via the slot 57 and pins 58. The energy is then in communication via the slot 56 in the cross-drive plate 52 to the pins 59 protruding out of the center hub 53. The array plate 60 is similar to the array plate previously described. This mechanism can anticipate two degrees of freedom but in this case one only is allowed. This mechanism has capabilities well beyond the capabilities of typical shaft alignment devices.

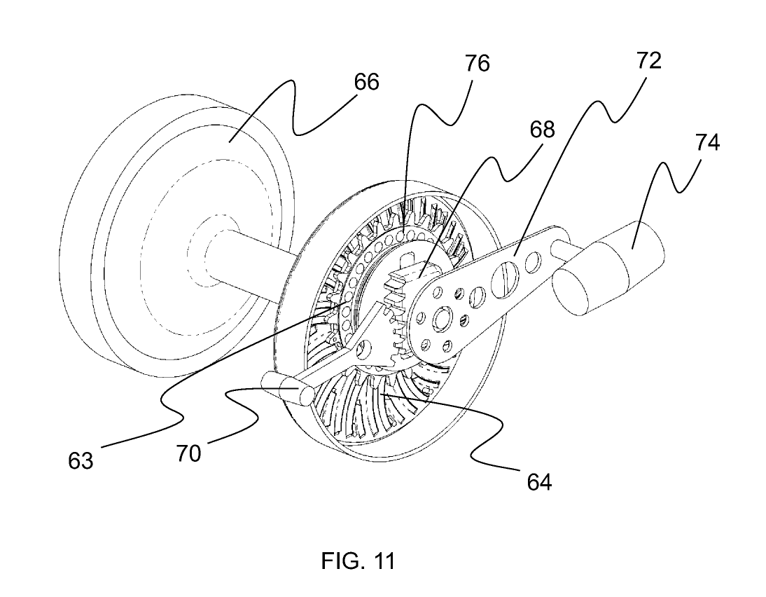

In a further embodiment the variable transmission system may be implemented on a fishing reel or winch application as shown in FIG. 11. In this configuration the shaft 62 (not shown) drive ring 63 and array plate 64 are within a housing 66 with the center hub 68 being actuated by a geared lever 70. The reel crank 72 with handle 74 travels up and down with the center hub 68 and by biasing the center hub 68 against a hub spring 76 (not shown) the variable transmission system under heavy loads would automatically shift into a lower gear and then as the load decreases the hub spring 76 would bias the center hub 68 back into a higher ratios for faster retrieval.

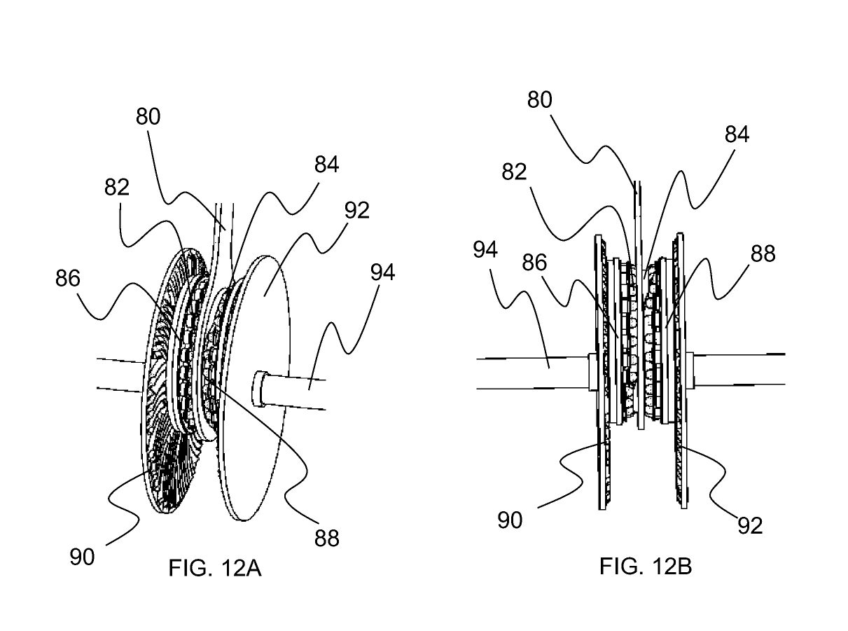

In a further embodiment shown in FIGS. 12A and 12B, an external force or adjustment mechanism 80 is positioned between a first and second position hub 82 and 84 with a first and second drive ring 86 and 88 and a first and second array plate 90 and 92 aligned along a shaft 94 within a series configuration. In this application very high gear ratios are attainable in a compact arrangement. For example, by placing a transmission system assembly having an active gear ratio range of 5:1 within a series of two systems having similar active gear ratios, the combined transmission system will result in an infinitely variable transmission system having a range of active gear ratios to 25:1. Alignment of the 100 degree window of each position hub must be oriented in an opposing manner to provide a maximum active gear ratio within the system.

The invention has been described in detail with particular reference to certain preferred embodiments thereof, but it will be understood that variations and modifications can be effected within the spirit and scope of the invention.

What is claimed is:

1. A variable power transmission mechanism for producing a desired torque comprising:
at least one hub having a slot aligned along a shaft;
at least one drive ring having at least one pin assembly positioned adjacent the at least one hub along the shaft;
at least one array plate positioned adjacent the at least one drive ring; and
wherein adjustment of the hub and slot relative to the shaft forces the at least one pin assembly to engage the at least one array plate and change the torque produced by the variable power transmission mechanism.

2. The variable power transmission mechanism of claim 1 wherein an adjustment of the hub and slot relative to the shaft causes one of an increased and decreased torque in the variable power transmission mechanism.

3. The variable power transmission mechanism of claim 1 wherein the array plate further comprises a plurality of primary pitch arrays radially extending from a center of the at least one array plate and a plurality of parallel constant pitch arrays aligned between the primary pitch arrays.

4. The variable power transmission mechanism of claim 1 wherein the position hub further comprises a cam lobe to engage the pin assembly to the arrays of the array plate during a segment of rotation.

5. The variable power transmission mechanism of claim 1 wherein the pin assembly further comprises a spring loaded body having a rim.

6. The variable power transmission mechanism of claim 5 wherein spring loaded body of the pin assembly compresses when overrun by an array during a segment of rotation.

7. The variable power transmission mechanism of claim 5 wherein the position hub further comprises a ledge to engage the rim of the pin assembly and hold the pin assembly away from the array plate during a segment of rotation.

8. A method for producing a desired torque from a variable power transmission mechanism comprising the steps of;
aligning at least one array plate along a stationary axle;
aligning at least one drive ring having at least one pin assembly adjacent the array plate;
affixing at least one adjustable hub to the axle adjacent the drive ring; and
moving the adjustable hub to force the at least one pin assembly to engage the array plate and alter the torque produced by the variable power transmission mechanism.

9. The method for producing a desired torque from a variable power transmission mechanism of claim 8 further comprising the step of moving the adjustable hub to a first position to increase torque and to a second position to decrease torque.

10. The method for producing a desired torque from a variable power transmission mechanism of claim 8 further comprising the step of arranging a plurality of primary arrays radially from a center of the array plate and arranging a plurality of parallel constant pitch arrays between the plurality of primary arrays.

11. The method for producing a desired torque from a variable power transmission mechanism of claim 10 further comprising the step of engaging a tooth profile of the at least one pin assembly with the plurality of primary and constant pitch arrays of the array plate.

12. The method for producing a desired torque from a variable power transmission mechanism of claim 8 further comprising the steps of engaging a cam lobe with at least one pin assembly during a segment of rotation; and
forcing the pin assembly towards the array plate.

13. The method for producing a desired torque from a variable power transmission mechanism of claim 8 further comprising the steps of engaging a rim of the at least one pin assembly with a shelf of the adjustable hub; and
holding the pin assembly away from the array plate.

14. The method for producing a desired torque from a variable power transmission mechanism of claim 8 further comprising the steps of spring loading the at least one pin assembly; and
compressing the spring when overrun by plurality of primary and constant pitch arrays of the array plate.

15. The method for producing a desired torque from a variable power transmission mechanism of claim 8 further comprising the steps of combining a first and a second transmission mechanism along the axle to increase the range of gear ratios.
